(19) United States
(12) Patent Application Publication
(10) Pub. No.: US 2023/0279285 A1
(43) Pub. Date: Sep. 7, 2023

(54) PETROLEUM COKE PROPPANT PARTICULATES AND METHODS RELATED THERETO

(71) Applicant: ExxonMobil Technology and Engineering Company, Spring, TX (US)

(72) Inventor: Robert M. SHIRLEY, The Woodlands, TX (US)

(21) Appl. No.: 18/170,889

(22) Filed: Feb. 17, 2023

Related U.S. Application Data
(60) Provisional application No. 63/268,720, filed on Mar. 1, 2022.

(51) Int. Cl. C09K 8/80; C09K 8/62

(52) U.S. Cl. CPC C09K 8/80; C09K 8/62

(57) ABSTRACT

Proppant particulates like sand are commonly used in hydraulic fracturing operations to maintain one or more fractures in an opened state following the release of hydraulic pressure. Fracturing fluids and methods of hydraulic fracturing may also use proppant particulates composed of agitated petroleum coke particles (referred to as agitated petroleum coke proppant particulates). In some instances, the agitated petroleum coke proppant particulates are characterized by a particle density of equal to or less than about 1.6 grams per cubic centimeter. The agitation processing of the present disclosure can remove petroleum coke particles having initiated cracking or scissions that are prone to fines production.

### CROSS-REFRENCE TO RELATED APPLICATION

This application claims the benefit of U.S. Provisional Application Serial No. 63/268,720, entitled “Petroleum Coke Proppant Particulates and Methods Related Thereto,” filed Mar. 1, 2022, the disclosure of which is hereby incorporated by reference in its entirety.

### FIELD OF INVENTION

This application relates to fracturing operations and petroleum coke proppant particulates employed therein and, in particular, to agitation methods for preparation of the petroleum coke proppant particulates.

### BACKGROUND OF THE INVENTION

A wellbore may be drilled into a subterranean formation in order to promote removal (production) of a hydrocarbon or water resource therefrom. In many cases, the subterranean formation needs to be stimulated in some manner in order to promote removal of the resource. Stimulation operations may include any operation performed upon the matrix of a subterranean formation in order to improve fluid conductivity therethrough, including hydraulic fracturing, which is a common stimulation operation for unconventional reservoirs.

Hydraulic fracturing operations pump large quantities of fluid into a subterranean formation (e.g., a low-permeability formation or “tight” formation) under high hydraulic pressure to promote formation of one or more fractures within the matrix of the subterranean formation and create high-conductivity flow paths. Primary fractures extending from the wellbore and, in some instances, secondary fractures extending from the primary fractures, possibly dendritically, may be formed during a fracturing operation. These fractures may be vertical, horizontal, or a combination of directions forming a tortuous path.

Proppant particulates are often included in a carrier fluid in order to keep the fractures open after the hydraulic pressure has been released following a hydraulic fracturing operation. Upon reaching the fractures, the proppant particulates settle therein to form a proppant pack to prevent the fractures from closing once the hydraulic pressure has been released. Accordingly, the length and width of the propped fractures are correlative to the production capacity of the wellbore, and are related to the amount of proppant particulates and carrier fluid used as well as associated additives.

There are oftentimes difficulties encountered during hydraulic fracturing operations, particularly associated with deposition of proppant particulates in fractures that have been created or extended under hydraulic pressure. Because proppant particulates are often fairly dense materials (typically sand), effective transport of the proppant particulates may be difficult due to settling, making it challenging to distribute the proppant particulates into more remote reaches of a fracture network. In addition, fine-grained particles (referred to as “fines”) produced from crushing of sand proppant particulates within the fractures can also lessen fluid conductivity, which may decrease production rates and/or necessitate wellbore cleanout operations.

### SUMMARY OF THE INVENTION

This application relates to fracturing operations and petroleum coke proppant particulates employed therein and, in particular, to agitation methods for preparation of the petroleum coke proppant particulates.

In nonlimiting aspects of the present disclosure, a proppant particulate is provided. The proppant particulate comprises a petroleum coke particle composed of at least one of fluid coke or flexicoke, wherein the petroleum coke particle has undergone agitation processing.

In nonlimiting aspects of the present disclosure, a fracturing fluid is provided. The fracturing fluid comprising a carrier fluid; and proppant particulates comprising a petroleum coke particle composed of fluid coke or flexicoke, wherein the petroleum coke particle has undergone agitation processing.

In nonlimiting aspects of the present disclosure, a method is provided including providing petroleum coke particles composed of fluid coke or flexicoke; and agitation processing the petroleum coke particles, thereby producing agitation processed petroleum coke proppant particulates.

These and other features and attributes of the disclosed petroleum coke lost circulation material of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 illustrates an image of petroleum coke prior to agitation processing.

FIG. 2 illustrates a scanning electron microscope image (150X magnification) of observed inherent fissures upon petroleum coke prior to agitation processing.

FIG. 3 illustrates a scanning electron microscope image (500X magnification) of observed inherent fissures upon petroleum coke prior to agitation processing.

FIG. 4 illustrates a scanning electron microscope image (40X magnification) of petroleum coke prior to agitation processing and after crushing and sintering along inherent fissures.

### DETAILED DESCRIPTION OF THE INVENTION

This application relates to fracturing operations and petroleum coke proppant particulates employed therein and, in particular, to agitation methods for preparation of the petroleum coke proppant particulates.

As discussed above, proppant particulates can be used effectively during fracturing operations, and are generally a readily available low cost and low acid solubility option, available in a wide range of sizes. However, oftentimes there are difficulties encountered during a fracturing operation. Proppant particulates are delivered to a wellbore in a carrier fluid and maintained in suspension through the use of fluid viscosity, as well as turbulence controlled by fluid flow (pump) rate. Adequate suspension and transport of the proppant particulates in a carrier fluid is needed to facilitate formation of long and wide fractures that are highly conductive. Moreover, fine-grained particles (referred to as “fines”) produced from crushing of deposited proppant particulates forming a “proppant pack” upon removal of hydraulic pressure can plug the proppant pack and lessen a fracture’s permeability and conductivity, thereby negatively impacting the wellbore’s productivity.

Traditional proppant particulates include relatively high density sand (~2.5-2.7 grams per cubic centimeter (g/cc)), bauxite (~3.5-3.8 g/cc), and ceramic (~2.0-3.0 g/cc), among others, and some issues may be associated with their use. These high density proppant particulates often result in transport difficulties, requiring particularly high density and/or high viscosity carrier fluids (e.g., high polymer viscosifier loading), thus necessitating relatively low fluid flow (pump) rates, which can lead to formation damage (e.g., flow resistance of fluid production), reduce fracture conductivity, or other complications. Moreover, viscosifier additives (e.g., gels or other viscosifiers) can be quite costly and are often further generally coupled with costly friction reducers (e.g., high molecular weight polyacrylamides) in large quantities to allow higher flow rates, and even still, the high density proppant particulates may settle relatively quickly out of the carrier fluid, thereby limiting the length and width of the propped fracture area.

Typical means of addressing the aforementioned issues involve the use of comparably small sized proppant particulates and/or the use of low density proppant particulates having a density closer to the density of the carrier fluid (e.g., water). Comparably small sized proppant (also referred to as “microproppant”), such as fine-grained sand, is able to stay in suspension longer than larger sized proppant particulates, which are typically 30-140 mesh, 100-600 micrometers (µm). However, these comparably small sized proppant may result in limited fracture conductivity due to small or no interstitial spaces between the proppant particulates for produced fluids to flow and may thus result in formation damage as well. Ultralight proppant particulates, with densities very close to the density of slickwater, a low viscosity fluid, for example, will stay suspended therein much longer compared to higher density traditional (e.g., sand) proppant particulates. However, lighter density materials usually have less compressive strength to sustain the fracture opening permanently after fracture closure. Available ultralight proppant options are either much more expensive than traditional proppant particulates, or have a comparably significantly lower compressive strength resulting in lower hydraulic conductivities.

The present disclosure alleviates the foregoing difficulties and provides related advantages as well. In particular, the present disclosure provides low density proppant particulates composed of petroleum coke, and, particularly, fluid coke and/or flexicoke, and methods of preparation related thereto. The low density petroleum coke proppant particulates described herein can be effectively suspended in a low viscosity carrier fluid and delivered at a high flow rate into a wellbore for hydraulic fracturing and rely on pre-agitation processing methods of petroleum coke to enhance the quality and functionality of the resultant petroleum coke proppant particulates, as well as enhanced final sieve throughput. Moreover, by using fluid coke and/or flexicoke as proppant particulates, CO₂ emissions are avoided as the petroleum coke can otherwise be used as a fuel source. In effect, using the petroleum coke proppant particulates described herein is a form of sequestering carbon that would otherwise contribute to CO₂ emissions.

In certain instances fluid coke and/or flexicoke (and even delayed coke) may not be of appropriate or desired size for use as proppant particulates, even after traditional sieving. According, the agitation processing methods of the present disclosure to prepare the petroleum coke proppant particulates may be performed after petroleum coke production at a hydrocarbon refinery, but may be performed immediately after or upon a storage and/or transport length of time, without departing from the scope of the present disclosure to achieve desired size. The agitation processing methods described hereinbelow produce petroleum coke proppant particulates having, as compared to traditional proppant particulates, faster final sieve throughput to achieve a desired petroleum proppant particulate size distribution as well as enhanced physical properties resulting in enriched hydraulic fracture conductivity, and thus wellbore productivity. The agitation processing methods of the present disclosure include, but are not limited to, transloading agitation, drying agitation, sieving agitation, and any combination thereof.

Illustrative petroleum coke (including either or both of fluid coke or flexicoke) proppant particulates of the present disclosure have been processed using one or more agitation processing methods and may have, among other characteristics, a particle density of equal to or less than about 1.6 g/cc, such as about 1.4 g/cc to about 1.6 g/cc, and are suitable for inclusion in a carrier fluid for use during a hydraulic fracturing operation within a horizontal, vertical, or tortuous wellbore, including hydrocarbon-bearing production wellbores and water-bearing production wellbores.

### Definitions and Test Methods

As used herein, the term “proppant particulate,” and grammatical variants thereof, refers to a solid material capable of maintaining open an induced fracture during and following a hydraulic fracturing treatment. The term “proppant pack,” and grammatical variants thereof, refers to a collection of proppant particulates residing within a fracture after hydraulic pressure is removed.

As used herein, the term “fracturing fluid,” and grammatical variants thereof, refers to a chemical mixture comprising a flowable carrier fluid, proppant particulates, and one or more optional additives. As used herein, the term “carrier fluid,” and grammatical variants thereof, refers to a flowable mixture absent proppant particulates and one or more optional additives.

As used herein, the term “petroleum coke,” and grammatical variants thereof, refers to fluid coke or flexicoke, and is used herein to represent both unless otherwise indicated. Accordingly, the “petroleum coke” of the present disclosure is distinguished from delayed coke and other types of coke that have very different properties and are not considered superior for use as proppant particulates. The petroleum coke described herein is used as a low density proppant particulate material for forming a proppant pack during a hydraulic fracturing operation.

The term “petroleum coke proppant particulate,” and grammatical variants thereof, refers to a proppant particulate material composed of fluid coke or flexicoke, and is used interchangeably with the term “petroleum coke proppant particles.”

The term “fluid coking” refers to a thermal cracking process utilizing fluidized solids for the conversion of heavy, low-grade hydrocarbon feeds into lighter products (e.g., upgraded hydrocarbons), producing fluid coke as a byproduct. By way of background, fluid coking is a carbon rejection process that is used for upgrading heavy hydrocarbon feeds and/or feeds that are challenging to process. The process produces a variety of lighter, more valuable liquid hydrocarbon products, as well as a substantial amount of fluid coke as byproduct. The fluid coke byproduct comprises high carbon content and various impurities.

The term “fluid coke,” and grammatical variants thereof, refers to the solid concentrated carbon material remaining from fluid coking. The term “fluid coke proppant particulates” refers to proppant particulates composed of fluid coke, and can be used interchangeably with the term “fluid coke proppant particles.”

The fluid coke proppant particulates described herein may have a carbon content of 75 weight percent (wt%) to 93 wt%, or 78 wt% to 90 wt%; a weight ratio of carbon to hydrogen of 30:1 to 50:1, or 35:1 to 45:1; an impurities content (weight percent of all components other than carbon and hydrogen) of 5 wt% to 25 wt%, or 10 wt% to 20 wt%; a sulfur content of 3 wt% to 10 wt%, or 4 wt% to 7 wt%; and a nitrogen content of 0.5 wt% to 3 wt%, or 1 wt% to 2 wt%, each encompassing any value and subset therebetween.

The term “FLEXICOKING™” (trademark of ExxonMobil Research and Engineering Company (“ExxonMobil”)) refers to a thermal cracking process utilizing fluidized solids and gasification for the conversion of heavy, low-grade hydrocarbon feeds into lighter hydrocarbon products (e.g., upgraded, more valuable hydrocarbons). By way of background, FLEXICOKING™ is based on fluidized bed technology developed by ExxonMobil, and is a carbon rejection process that is used for upgrading heavy hydrocarbon feeds (referred to as “residua”). Unlike fluid coking, which utilizes a reactor and a burner, the FLEXICOKING™ process uses a reactor, a heater, and a gasifier. The FLEXICOKING™ process is described in greater detail below.

Briefly, the FLEXICOKING™ process is one in which the flexicoke for forming the flexicoke gravel packing material described herein, integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement, which is typically about 496° C. to about 538° C. A return stream of coke sent from the gasifier to the heater provides the remainder of the heat requirement. The coke meeting the heat requirement is then circulated to the reactor and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor - the resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

The term “flexicoke” refers to the solid concentrated carbon material produced from FLEXICOKING™. The term “fluid coke proppant particulates” refers to proppant particulates composed of flexicoke, and can be used interchangeably with the term “flexicoke proppant particles.”

The flexicoke proppant particulates described herein may have a carbon content of 85 wt% to 99 wt%, or 90 wt% to 96 wt%; a weight ratio of carbon to hydrogen of 80:1 to 98:1, or 85:1 to 95:1; an impurities content (weight percent of all components other than carbon and hydrogen) of 1 wt% to 15 wt%, or 3 wt% to 10 wt%; a combined vanadium and nickel content of 3000 ppm to 45,000 ppm, or 3000 ppm to 15,000 ppm, or 5000 ppm to 30,000 ppm, or 30,000 ppm to 45,000 ppm; a sulfur content of 0 wt% to 5 wt%, or 0.5 wt% to 4 wt%; and a nitrogen content of 0 wt% to 3 wt%, or 0.1 wt% to 2 wt%, each encompassing any value and subset therebetween.

As used herein, the term “agitation processing,” and grammatical variants thereof, refers to one or more methods for cracking or scission along petroleum coke fractures to achieve desired size and eliminate or reduce inherent fissures that can lead to reduced crush strength. The agitation process produces particles that enhance final sieve throughput to obtain desired petroleum proppant particulates with the particular characteristics described herein. The term “agitation processing methods” can be used interchangeably with the terms “agitation processing,” “agitation methods,” “agitation operations,” and “agitation techniques.”

As used herein, the term “final sieve throughput,” and grammatical variants thereof, refers to the efficiency of a sieving apparatus to retain the input of particles having a desired size or size range and reject particles that are outside of the desired size or size range (e.g., oversized or undersized particles); “final sieving,” and grammatical variants thereof, refers to the last (if there are multiple) sieving operation prior to obtaining the desired size or size range, including agitation sieving for conducting the agitation processing methods described herein.

As used herein, the term “transloading agitation,” and grammatical variants thereof, refers to agitation of a material during transportation, or at the time of unloading the material from one mode of transportation to another or one mode of transportation to a storage or processing facility (e.g., storage vessel or barrel, or sand processing (sieving) facility).

As used herein, the term “drying agitation,” and grammatical variants thereof, refers to agitation of a material using one or more industrial drying apparatuses, such as those typically found in a refining facility or sand proppant particulate production facility.

As used herein, the term “sieving agitation,” and grammatical variants thereof, refers to agitation of a material using a modified industrial particle separator apparatus or modified industrial particle separator process, and is distinguished from final sieving as defined hereinabove.

As used herein, the term “particle density,” and grammatical variants thereof, with reference to the density of petroleum coke proppant particulates, refers to the density of the individual particles themselves, which may be expressed in grams per cubic centimeter (g/cc). The particle density values of the present disclosure are based on the American Petroleum Institute’s Recommended Practice 19C standard entitled “Measurement of Properties of Proppants Used in Hydraulic Fracturing and Gravel-packing Operations” (Second Ed., September 2020) (hereinafter “API RP-19C” of the same edition).

As used herein, the terms D50 are used to describe particle sizes of the petroleum coke proppant particulates. As used herein, the term “D50” refers to a diameter at which 50% of the sample (on a volume basis unless otherwise specified) is comprised of particles having a diameter less than said diameter value. Particle size can be determined by light scattering techniques, sieving analysis, or analysis of optical digital micrographs. Unless otherwise specified, laser particle size analysis is used for analyzing particle size of the petroleum proppant particulates described herein.

As used herein, the term “fracture conductivity” refers to the permeability of a proppant pack to conduct fluid at various stress (pressure) levels. The fracture conductivity values of the present disclosure are based on the American Petroleum Institute’s Recommended Practice 19D (API RP-19D) standard entitled “Measuring the Long-Term Conductivity of Proppants” (First Ed. May 2008, Reaffirmed May 2015).

As used herein, the term “crush strength” or “compressive strength,” and grammatical variants thereof, with reference to proppant particulates, refers to the uniaxial stress (compressive) load proppant particulates can withstand prior to crushing (e.g., breaking or cracking). The crush strength values of the present disclosure are based on API RP-19C. According to API RP-19C standards, adequate proppant particles should have a crush strength in which minimum number of fines are produced under a stress of 2000 psi, depending on the size of the particular gravel packing particles.

All numerical values within the detailed description and the claims herein are modified by “about” or “approximately” with respect to the indicated value, and take into account experimental error and variations that would be expected by a person having ordinary skill in the art.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

### Petroleum Coke Proppant Particulates Prepared by Agitation Processing Methods

The rate of settling of a proppant particulate within a carrier fluid at least in part determines its transport capacity within one or more fractures created during a hydraulic fracturing operation. The rate of settling of a proppant particulate may be determined using Equation 1:

$$\text{v} = \frac{{\text{ρ}}_{\text{p}} - {\text{ρ}}_{\text{f}}}{18 \text{η}} \text{g} {\text{σ}}^{2} \qquad \text{Equation 1,}$$

where v is the terminal velocity of the proppant particle; ρₚ - ρ_{f} is proportional to the density difference between the proppant particle and the carrier fluid; η is the viscosity of the carrier fluid; g is the gravitational constant; and σ² is proportional to the square of the proppant particulate diameter. As will be appreciated, proppant particulates having lower particle densities and/or smaller average particle sizes settle at a slower rate within an identical carrier fluid (thus having better transport) compared to higher particle density and/or larger average particle sized proppant particulates.

A proppant particulate’s crush strength is a measure of its ability to withstand compressive stresses within a fracture, as they must resist sustained loads within a fractured subterranean formation during the lifetime of a wellbore to maintain its conductivity. Proppant particulates that are not able to withstand the imposed stresses of a fracture will crush over time, resulting in the formation of fines that may be transported into the wellbore and through equipment with produced fluids and accumulate in sufficient quantities to decrease production rates and/or necessitate costly wellbore cleanout operations or equipment replacement. Accordingly, proppant particulates with higher crush strengths are favorable. Such higher strength proppant particulates would additionally serve to promote fracture conductivity, particularly under increasing stresses. According to API RP-19C standards, adequate proppant particulates should have a crush strength in which less than 10% of fines are produced under a stress of 5000 psi.

Proppant particulate efficacy is further related to fracture conductivity, characterized by the fluid flow rate in a propped fracture under gradient pressure, the fracture being propped by a proppant pack. Fracture conductivity, C_{f}, is the product of the proppant pack permeability, k, and its thickness, h, and may be determined using Equations 2 and 3:

$${\text{C}}_{\text{f}} = \text{kh} \qquad \text{Equation 2,}$$

$$\text{k} = \frac{1}{\text{C}} \frac{{\text{ϕ}}^{3}}{{\left(1 - \text{ϕ}\right)}^{2}} {\text{σ}}_{\text{eff}}^{2} {\text{Φ}}_{\text{s}}^{2} \qquad \text{Equation 3,}$$

where C is a constant; ϕ is the proppant pack void fraction; σ is the average particle size diameter of the proppant particulates; and Φ is a shape factor related to the asphericity of the proppant particulates. In tension with settling rate and transport, fracture conductivity favors proppant particulates having larger average particle size diameters, as well as thick proppant packs and narrow particle size distribution. Accordingly, the conductivity of a proppant pack is dependentat least in part on the size of the proppant particulates. Typically, proppant particulates having a relatively narrow size distribution may be preferred to maintain the flow path within the proppant pack, such that smaller (or irregular shaped) proppant particulates do not fill voids within the proppant pack.

As provided hereinabove and described in greater detail hereinbelow, the petroleum coke proppant particulates of the present disclosure are prepared by processing virgin petroleum coke, typically obtained directly from a hydrocarbon refining facility (termed “unprocessed” or “pre-processed” petroleum coke).

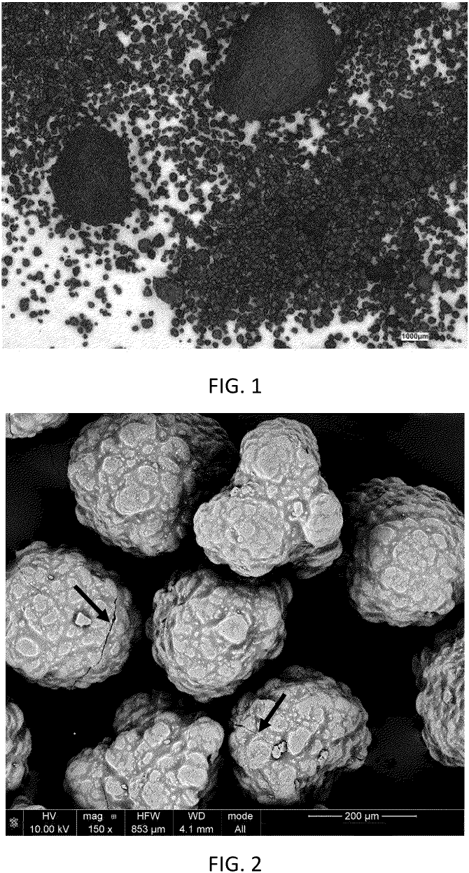

Referring to FIG. 1, illustrated is an image (photograph) of petroleum coke prior to agitation processing obtained from a refinery. As shown, the resultant unprocessed petroleum coke byproduct can vary quite substantially in size, noting the large petroleum coke masses surrounded by smaller, and in greater quantity, petroleum coke masses. As can be seen, the smaller unprocessed petroleum masses also vary in size. A laser particle size distribution was performed using the unprocessed petroleum coke of FIG. 1 (run in quadruplicate - Run 1-4) after removal of particles larger than 3 millimeters (mm). The unprocessed petroleum coke results are shown in Table 1.

TABLE 1

| Size (µm) | Run 1 (%) | Run 2 (%) | Run 3 (%) | Run 4 (%) |
|---|---|---|---|---|
| 51.8 | 0.16 | 0.09 | 0 | 0.27 |
| 58.9 | 0.71 | 0.52 | 0.27 | 0.92 |
| 66.9 | 1.79 | 1.42 | 0.96 | 2.06 |
| 76 | 3.42 | 2.8 | 2.19 | 3.67 |
| 86.4 | 5.52 | 4.58 | 3.93 | 5.61 |
| 98.1 | 7.87 | 6.53 | 6.04 | 7.64 |
| 111 | 10.14 | 8.39 | 8.26 | 9.44 |
| 127 | 11.95 | 9.86 | 10.27 | 10.73 |
| 144 | 12.95 | 10.69 | 11.73 | 11.29 |
| 163 | 12.88 | 10.74 | 12.36 | 11.01 |
| 186 | 11.64 | 10.02 | 12.03 | 9.97 |
| 211 | 9.4 | 8.65 | 10.75 | 8.34 |
| 240 | 6.52 | 6.88 | 8.73 | 6.42 |
| 272 | 3.61 | 5 | 6.29 | 4.5 |
| 310 | 1.31 | 3.27 | 3.85 | 2.8 |
| 352 | 0.11 | 1.88 | 1.82 | 1.5 |
| 400 | 0 | 0.95 | 0.51 | 0.63 |
| 454 | 0 | 0.49 | 0 | 0.16 |
| 516 | 0 | 0.44 | 0 | 0 |
| 586 | 0 | 0.66 | 0 | 0 |
| 666 | 0 | 0.99 | 0 | 0.16 |
| 756 | 0 | 1.24 | 0 | 0.34 |
| 859 | 0 | 1.31 | 0 | 0.48 |
| 976 | 0 | 1.16 | 0 | 0.54 |
| 1110 | 0 | 0.84 | 0 | 0.53 |
| 1260 | 0 | 0.45 | 0 | 0.44 |
| 1430 | 0 | 0.14 | 0 | 0.31 |
| 1630 | 0 | 0 | 0 | 0.17 |
| 1850 | 0 | 0 | 0 | 0.06 |

As shown in Table 1, the tested unprocessed petroleum coke varies between about 50 µm and about 1900 µm with a D50 in the range of about 130 µm to about 160 µm, although only a rather small percentage are less than about 60 µm or greater than about 1000 µm. Accordingly, the average diameter of unprocessed petroleum coke may be in the range of about 60 µm to about 1000 µm, such as 60 µm to 800 µm, or 60 µm to 600 µm, or 60 µm to 450 µm, or 60 µm to 350, or 60 µm to 250 µm, or 60 µm to 150 µm, or 150 µm to 550 µm, or 250 µm to 550 µm, or 350 µm to 550 µm, or 450 µm to 550 µm, encompassing any value and subset therebetween. In certain embodiments, the unprocessed petroleum coke has an average diameter in the range of 60 µm to 600 µm. These size ranges are comparable to traditional sand proppant.

Table 2 below shows particle densities in g/cc per API RP-19C and the maximum, minimum, and average diameters in µm of sieved agitation processed petroleum coke of FIG. 1 compared to traditional sand proppant of approximately the same size, and settling rates of each in feet per min (ft/min) per Stokes’ law in a carrier fluid having a density of 1.1 g/cc. Two traditional sand proppants were evaluated for settling: (1) 40/70 size, labeled “C1” and (2) 50/140 mesh size, labeled “C2.” One agitation processed petroleum coke sample was evaluated for settling: 70/140 size, labeled “E1.” The densities are labeled ρ; the maximum, minimum, and average diameter values are labeled Øₘₐₓ, Øₘᵢₙ, and O_{D50}, respectively; and the average settling velocities of the maximum, minimum, and average diameter values are labeled vₘₐₓ, vₘᵢₙ, and v_{D50}, respectively.

TABLE 2

| | ρ | Øₘₐₓ | Øₘᵢₙ | Ø_{D50} | vₘₐₓ | vₘᵢₙ | v_{D50} |
|---|---|---|---|---|---|---|---|
| | g/cc | µm | | | ft/min | | |
| C1 | 2.65 | 425 | 212 | 288 | 15.013 | 3.736 | 6.894 |
| C2 | 2.65 | 300 | 105 | 206 | 7.480 | 0.916 | 3.527 |
| E1 | 1.50 | 212 | 105 | 165 | 1.205 | 0.177 | 0.584 |

As provided in Table 2, the settling velocities of the E1 sample are significantly reduced compared to both C1 and C2 regardless of particle size. Moreover, the variability in settling velocity of the petroleum coke is reduced compared to traditional sand proppant; for example, the most common traditional proppant used in the Permian basin is 100 mesh and 40/70 mesh, thus ranging from 150 µm to 400 µm (of course, some operators use smaller or larger sizes).

### Petroleum Coke Agitation Processing Methods

As described in greater detail below, with reference to agitation processed petroleum coke to produce the petroleum coke proppant particulates of the present disclosure, hydraulic fracturing operations require effective proppant particulates to maintain the permeability and conductivity of a production well, such as for effective hydrocarbon recovery. Effective proppant particulates are typically associated with a variety of particular characteristics or properties, including efficient proppant particulate transport within a carrier fluid (density and associated settling rates), sufficient compressive strength to maintain fractures propped upon the removal of hydraulic pressure, and efficient conductivity once the wellbore is brought on production (particle size and particle size distribution).

The present disclosure utilizes readily available, cost-effective petroleum coke in combination with one or more agitation processing methods to produce petroleum coke proppant particulates. Petroleum coke is produced during refining processes and is often exported as a low value product stream, and it is noted herein that the low density of petroleum coke and its comparable or improved compressive strength compared to traditional proppant particulates lends the material for use as cost-effective, readily-available proppant particulates. The agitation processing methods described herein ensure that petroleum coke byproduct is pre-processed to reduce final sieve throughput, thereby reducing traditional processing times, to produce final sieved petroleum coke proppant particulates of desired size or size distribution. While techniques exist for sieving traditional proppant particulates (e.g., sand), no industrial machinery exists for preparing sieved petroleum coke and no methods are known to produce petroleum coke having a sieved size or size distribution for proppant particulate applications (e.g., properties tailored for its use as proppant particulates).

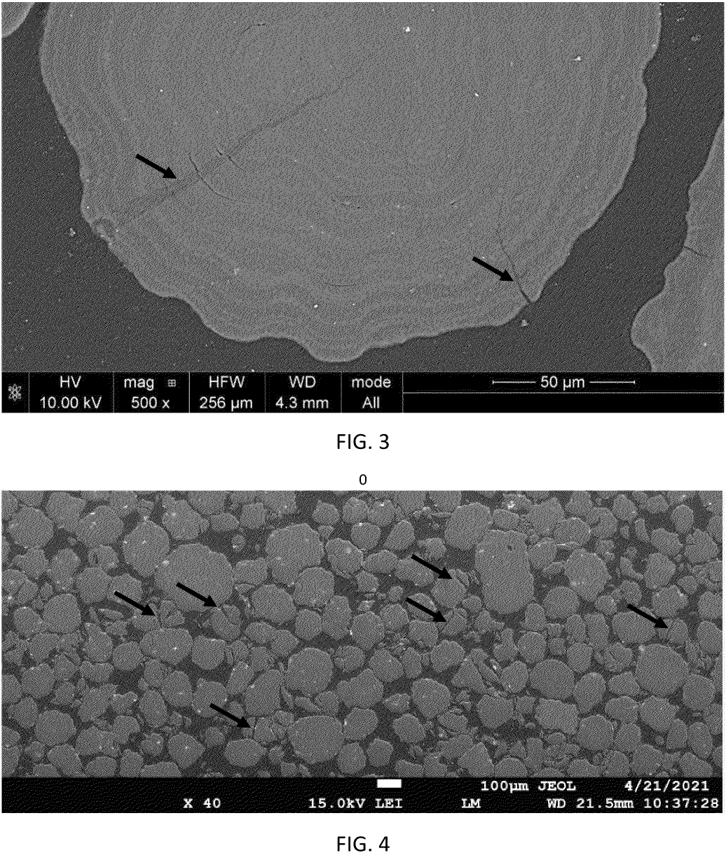

Unprocessed petroleum coke particulates exhibit inherent fissures, as shown in FIGS. 2 and 3. FIG. 2 is a scanning electron microscope image (150X magnification) of petroleum coke prior to agitation processing showing fissures (see representative arrow) on the surface of the particles. FIG. 3 is another example of a scanning electron microscope image (500X magnification) of petroleum coke prior to agitation processing showing fissures (see representative arrows) on the surface of the particles. The petroleum coke shown in FIG. 4 is resin mounted and polished for internal structure visibility. As shown in FIG. 3, it is clear that many of the fissures are healed and not open voids. However, whether healed or a void, the fissures present potential weakness that may cause such petroleum coke used as proppant to crush and reduce conductivity of a proppant fracture, as described hereinabove. Indeed, FIG. 4 illustrates a scanning electron microscope image (40X magnification) of petroleum coke prior to agitation processing and after crushing at 1000 psi. As shown in FIG. 4, several of the crushed petroleum coke particles have indeed sintered or split (see representative arrows) due to failure along the inherent fissures, producing fines which may be too small or an otherwise undesirable size for use in a proppant pack.

Without being bound by theory, it is believed that the agitation processing methods of the present disclosure can be used to address the inherent fissures of unprocessed petroleum coke prior to final sieving such that they can easily be removed during a final sieving process, thus enhancing conductivity for use in a hydraulic fracturing operation (i.e., fines can migrate, reduce porosity and limit hydraulic conductivity of a resultant proppant pack).

The agitation techniques of the present disclosure are used to process unprocessed petroleum coke directly obtained from the refining process such that reduced final sieve throughput can be obtained. The agitation processing methods described herein may include, but are not limited to, transloading agitation, drying agitation, sieving agitation, and any combination thereof.

Transloading agitation involves agitation of unprocessed petroleum coke during one or more transloading operations. For example, many transloading operations (e.g., using trucks, rail cars, and the like) include one or more mechanical agitators used to facilitate the emptying (and transfer) of materials, such as traditional proppant particulates. These agitators are used in order to facilitate removal of materials that are too fine to flow under their own weight. Unlike these traditional proppant particulates, unprocessed petroleum coke does not require agitation for emptying and is able to be removed using its own weight. For use in the present disclosure, transloading operations not heretofore used as an agitator with petroleum coke, may be employed to break the fractures within unprocessed petroleum coke or otherwise remove fines from the petroleum coke that can result in decreased fracture conductivity.

Drying agitation involves agitation of unprocessed petroleum coke using one or more industrial dryers (e.g., fluid bed dryer, rotary dryer, and the like). For example, many sieving facilities, which themselves may be converted to coke sieving facilities, include dryers that are used prior to sieving sand or other materials for use in a subterranean formation operation (e.g., for proppant particulates but also other potential particles, such as gravel packing materials). These dryers are used to prevent “binding” of sieve filters; that is, to prevent sieve apertures from becoming blocked with material and thus precluding particles of the material from traversing the sieve aperture even if correctly sized. These industrial dryers further provide a considerable amount of motion so as to provide maximum surface area between air (typically hot air) and the materials for which binding is intended to be prevented. Unprocessed petroleum coke is a low-moisture material, generally having a moisture content of less than 3% by weight and accordingly does not require drying. For use in the present disclosure, the industrial dryers not heretofore used as an agitator with petroleum coke, may be employed to break the fissures within unprocessed petroleum coke or otherwise remove fines from the petroleum coke that can result in decreased fracture conductivity. Moreover, there would be no need to utilize excess energy to heat the air within the dryer, as the petroleum coke does not require drying due the its low moisture content, although its use does not depart from the scope of the present disclosure. Further, there may be no need to utilize compressed air, although its use does not depart from the scope of the present disclosure.

Sieving agitation involves agitation using one or more particle separator apparatuses comprising a plurality of separator trays (e.g., at least 2, or between 2 to about 20, or more). An example of a suitable particle separator apparatus includes, but is not limited to, ROTEX® High Performance Screeners (Cincinnati, OH) designed to remove fines. Typically, such particle separators are used to create multiple cuts of a desired material (e.g., traditional proppant particulates). The number of separator trays are typically selected based on the ability to create the desired cut within a particular accuracy range (e.g., a tolerance window above and below the desired cut size), which may further be dependent upon material feed rate and the desired particle size. Typically, only the amount of separator trays required to achieve the desired size are used; however, not heretofore used as an agitator with unprocessed petroleum coke, the particle separator may be employed using additional separator trays beyond what is needed to achieve a particular size thereof to break the fractures within unprocessed petroleum coke or otherwise remove fines from the petroleum coke that can result in decreased fracture conductivity. Moreover, multiple (e.g., at least two) particle separator devices may be used to achieve the excess agitation for use in the present disclosure, such as beyond the less than 10% requirement of API STD 19C (2^{nd} ed. August 2018 pg. 17).

Particle separators additionally may employ small rubber balls between each separator tray to provide further agitation and prevent binding, as described above. The rubber balls assist with the prevention of blinding (blocking) of sieve openings, but can often cause deterioration of the separator trays. For use in the present disclosure, the small rubber balls between the separator trays not heretofore used as an agitator with petroleum coke, may be employed in increased number (compared to the typical number) to break the fractures within unprocessed petroleum coke or otherwise remove fines from the petroleum coke that can result in decreased fracture conductivity.

While the present disclosure refers primarily to transloading agitation, drying agitation, and sieving agitation, it is to be appreciated that other devices in movement (e.g., rotation about any axis, shaking, tidal, erratic), preferably those that are used in sand sieving operations for use in subterranean formation operations, such as conditioning and flotation equipment, hydrocyclone equipment, and the like, and any combination thereof, including all of which are described herein.

The agitated petroleum coke proppant particulates having the characteristics described herein exhibit the aforementioned properties, as well as others, which make them not only a viable alternative for traditional proppant particulates, but further a surprising substitute with enhanced functionality.

After agitation is complete, traditional final sieving operations may be performed to arrive at the desired size for forming the petroleum coke proppant particulates of the present disclosure, including the D50 range listed above for unprocessed petroleum coke and suitable for use as proppant particulates, being in the range of about 60 µm to about 600 µm, encompassing any value and subset therebetween. In one or more aspects, the petroleum coke proppant particulates have an average sieve distribution (diameter) from 230 mesh to 30 mesh, or 200 mesh to 50 mesh, or 150 mesh to 100 mesh, encompassing any value and subset therebetween. In some aspects, a smaller petroleum coke proppant particulate (e.g., 100 µm to 200 µm, or 70 to 140 mesh) D50 may be desirable in order to reach far-field areas of fractures for more efficient fracture conductivity.

The particle density of the final, agitated petroleum coke proppant particulates of the present disclosure is equal to or less than about 1.7 grams per cubic centimeter (g/cc), including in the range of 1.4 g/cc to 1.6 g/cc, or 1.4 g/cc to 1.5 g/cc, or 1.5 g/cc to 1.6 g/cc, encompassing any value and subset therebetween. As provided above, traditional proppant particulates generally have particle densities greater than about 2.0 g/cc (e.g., sand proppant particulates have particle densities of about 2.65 g/cc). Thus, the petroleum coke proppant particulates described herein have substantially lesser particle densities compared to traditional proppant particles, which is indicative of their comparably more effective transport and lower settling rates within a carrier fluid used as part of a fracturing fluid. Moreover, as described in greater detail below, the density of the carrier fluids for use in the embodiments of the present disclosure may be in the range of 1.0 g/cc to 1.5 g/cc, or 1.0 g/cc to 1.2 g/cc, encompassing any value and subset therebetween. Accordingly, the agitated petroleum coke proppant particulates also have a density closer to the desired carrier fluid compared to traditional proppant particulates and will, as per Stokes’ law, exhibit better suspension for this reason.

Further, the low density of the petroleum coke proppant particles permits a reduction in viscosifier (e.g., polymer or bentonite clay) load in the carrier fluid, thereby reducing costs of the fracturing operations and also permitting a reduction in pump rates compared to traditional fracturing operations. Moreover, selection of an agitated petroleum coke proppant particulate material having buoyancy similar to or the same density as compared to the carrier fluid can further enhance pumping flexibility, better ensuring that the particulates will remain in suspension.

The particular crush strength of an agitated petroleum coke proppant particulate may depend on a number of factors including, but not limited to, the overpressure gradient, the depth of the wellbore, the integrity of the subterranean formation (e.g., conventional or unconventional formation), and the like, and any combination thereof. In some aspects, the crush strength of the agitated petroleum coke proppant particulates described herein meet API RP-19C standards and may be in the range of 2000 pounds per square inch (psi) to 12,000 psi, or 3000 psi to 6000 psi, or 5000 psi to 10,000 psi, or 7500 psi to 12,000 psi, encompassing any value and subset therebetween.

The Krumbein Chart provides an analytical tool to standardize visual assessment of the sphericity and roundness of particles, including lost circulation particles. Each of sphericity and roundness is visually assessed on a scale of 0 to 1, with higher values of sphericity corresponding to a more spherical particle and higher values of roundness corresponding to less angular contours on a particle’s surface. According to API RP-19C standards, the shape of a proppant particulate is considered adequate for use in fracturing operations if the Krumbein value for both sphericity and roundness is ≥ 0.6. The sphericity of the agitated petroleum coke proppant particulates of the present disclosure are in the range of 0.6 to 1.0, encompassing any value and subset therebetween. The roundness of the agitated petroleum coke proppant particulates of the present disclosure are in the range of 0.6 to 1.0, encompassing any value and subset therebetween.

The agitated petroleum coke proppant particulates material having the characteristics described herein exhibit the aforementioned properties, as well as others, which make them not only a viable alternative for proppant particulate material, but further a surprising substitute with enhanced functionality, particularly after agitation. Moreover, the agitated petroleum coke proppant particulates, although derived from refinery operations, exhibit only minimal metal leaching in a wellbore environment and are compatible with various carrier fluids and additives.

### Fracturing Operations Using Agitated Petroleum Coke Proppant Particulates

The agitated petroleum coke proppant particulates described herein may be used as part of a fracturing fluid for use in a hydraulic fracturing operation, the fracturing fluid comprising a flowable (e.g., liquid or gelled) carrier fluid (which may or may not be mixed with sand proppant particulates) and one or more optional additives. This fracturing fluid can be formulated at the well site in a mixing process that is conducted while it is being pumped. When the fracturing fluid is formulated at the well site, agitated petroleum coke proppant particulates can be added in a manner similar to the known methods for adding traditional proppant particulates (e.g., sand) into the fracturing fluid, as described in greater detail below.

The carrier fluid of the present disclosure may comprise an aqueous-based fluid or a nonaqueous-based fluid. Aqueous-based fluids may include, but are not limited to, fresh water, salt water (including seawater), treated water (e.g., treated production water), other forms of aqueous fluid, and any combination thereof. Nonaqueous-based fluids may include, for example, supercritical carbon-dioxide, liquid nitrogen, oil-based fluids (e.g., hydrocarbon, olefin, mineral oil, fatty acid), alcohol-based fluids, and any combination thereof.

One aqueous-based fluid class referred to as slickwater can be used with the low density agitated petroleum coke proppant particulates of the present disclosure. Slickwater aqueous-based fluids have a relatively low viscosity of generally less than 100 centipoise (cP), or in the range of 3 cP to 100 cP, such as 10 cP to 50 cP, or 10 cP to 25 cP, or 25 cP to 50 cP, encompassing any value and subset therebetween, and have low densities in the in the range of 1.0 g/cc to 1.5 g/cc, or 1.0 g/cc to 1.2 g/cc, encompassing any value and subset therebetween. As such, and unlike traditional high density proppant particulates, the agitated petroleum coke proppant particulates suspended in a slickwater carrier fluid, whether additional additives are included or not, can be pumped at high flow rates, and thus at high turbulence, to facilitate fracturing while maintaining the agitated petroleum coke proppant particulates in suspension.

In various aspects, the viscosity and density of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers. It is to be noted, however, that because the agitated petroleum coke proppant particulates of the present disclosure exhibit particularly low density, the carrier fluid can be void of foaming or gelling agents or may otherwise comprise a reduced amount of foaming or gelling agents compared to a carrier fluid comprising traditional proppant particulates.

In addition, the carrier fluids may comprise one or more additives such as, for example, dilute aids, biocides, breakers, corrosion inhibitors, crosslinkers, friction reducers (e.g, polyacrylamides), gelling agents (e.g., hydroxypropyl guar), salts (e.g., KCl), oxygen scavengers, pH control additives, scale inhibitors, surfactants, weighting agents, inert solids, fluid loss control agents, emulsifiers, emulsion thinners, emulsion thickeners, viscosifying agents, particles, lost circulation materials, foaming agents (e.g., air or other gases, such as CO₂, N₂, and the like), buffers, stabilizers, chelating agents, mutual solvents, oxidizers, reducers, clay stabilizing agents, and any combination thereof.

The methods described herein include preparation of fracturing fluid, which is not considered to be particularly limited, because the agitated petroleum coke proppant particulates are capable of transportation in dry form or as part of a wet slurry from a manufacturing site (e.g., a refinery or synthetic fuel plant). Dry and wet forms may be transported via truck or rail, and wet forms may further be transported via pipelines. The transported dry or wet form of the agitated petroleum coke proppant particulates may be added to a carrier fluid, including optional additives, at a production site, either directly into a wellbore or by pre-mixing in a hopper or other mixing equipment. In some aspects, for example, when the entirety of the proppant particulates within the fracturing fluid at a given time are agitated petroleum coke proppant particulates, slugs of the dry or wet form may be added directly to the fracturing fluid (e.g., as it is introduced into the wellbore). These slugs of only agitated petroleum coke coated proppant particulates may be followed by subsequent slugs of again, agitated petroleum coke coated proppant particulates or of a mixture of agitated petroleum coke coated proppant particulates and other traditional proppant particulates. In other aspects, such as when other traditional proppant particulate types are combined with the agitated petroleum coke coated proppant particulates, a portion or all of the fracturing fluid may be pre-mixed at the production site or each proppant type may be added directly to the fracturing fluid separately or simultaneously. Any other suitable mixing or adding of the agitated petroleum coke proppant particulates to produce a desired fracturing fluid composition may also be used, without departing from the scope of the present disclosure.

The methods of hydraulic fracturing suitable for use in one or more aspects of the present disclosure involve pumping fracturing fluid comprising agitated petroleum coke proppant particulates at a high pump rate into a subterranean formation to form at least a primary fracture, as well as potentially one or more secondary fractures extending from the primary fracture, one or more tertiary fractures extending from the secondary fractures, and the like (all collectively referred to as a “fracture”). In an embodiment, this process is conducted one stage at a time along a horizontal well. The stage is hydraulically isolated from any other stages which have been previously fractured. In one embodiment, the stage being fractured has clusters of perf holes (e.g., perforations in the wellbore and/or subterranean formation) allowing flow of hydraulic fracturing fluid through a metal tubular casing of the horizontal well into the formation. Such metal tubular casings are installed as part of the completions when the well is drilled and serve to provide mechanical integrity for the horizontal wellbore. In some aspects, the pump rate for use during hydraulic fracturing may be at least about 10 barrels per minute (bbl/min), or at least about 30 bbl/min, and more in excess of about 50 bbl/min and less than 200 bbl/min at one or more time durations during the fracturing operation (e.g., the rate may be constant, steadily increased, or pulsed), encompassing any value and subset therebetween. These high rates may, in some aspects, be utilized after about 10% of the entire volume of fracturing fluid to be pumped into the formation has been injected. That is, at the early periods of a hydraulic fracturing operation, the pump rate may be lower and as fracture(s) begin to form, the pump rate may be increased. Generally, the average pump rate of the fracturing fluid throughout the operation may be about 10 bbl/min, or about 15 bbl/min, or about 25 bbl/min. Typically, the pump rate during a fracturing operation may be, at any one time, in the range of about 20 bbl/min to about 150 bbl/min, or about 40 bbl/min to about 120 bbl/min, or about 40 bbl/min to about 100 bbl/min, encompassing any value and subset therebetween.

In various aspects, the methods of hydraulic fracturing described herein may be performed wherein the concentration of the proppant particulates (including agitated petroleum coke proppant particulates and any other traditional proppant particulates) within the injected fracturing fluid is altered (i.e., on-the-fly while the fracturing operation is being performed, such that hydraulic pressure is maintained within the formation and fracture(s)). For example, in some aspects, the initially injected fracturing fluid may be injected at a low pump rate and may comprise proppant particulates in an amount of 0 volume % (vol%) to about 1 vol% of the fracturing fluid. As one or more fractures begin to form and grow, the pump rate is increased and the concentration of proppant particulates may be increased in a stepwise fashion (with or without a stepwise increase in pump rate) with a maximum concentration of proppant particulates reaching about 2.5 vol% to about 20 vol% of the fracturing fluid, encompassing any value and subset therebetween, which may be solely agitated petroleum coke proppant particulates. For example, the maximum concentration of proppant particulates may reach at least 2.5 vol%, or at least about 8 vol%, or at least about 16 vol% of the fracturing fluid. In some aspects, all of the proppant particulates are agitated petroleum coke proppant particulates. In other aspects, at one or more time periods during the hydraulic fracturing operation, at least about 2 vol% to about 100 vol% of any proppant particulates suspended within the fracturing fluid are agitated petroleum coke proppant particulates, such as at least about 2 vol%, or at least about 15 vol%, or at least about 25 vol%, or 100 vol%, or in the range of about 20 vol% to about 50 vol%, encompassing any value and subset therebetween. When the agitated petroleum coke proppant particulates are included in fracturing fluid with other proppant particulates, it is expected that at least about 5 vol% to about 50 vol%, such as about 25 vol% to about 50 vol% of any proppant particulates will be the agitated petroleum coke proppant particulates, encompassing any value and subset therebetween. Moreover, when combined the average diameters of any proppant particulates may be the same or different, without departing from the scope of the present disclosure.

In one or more aspects, the agitated petroleum coke proppant particulates may be introduced into a stage at an early time during the particular pumping design (i.e., an early phase during pumping within a particular stage). For example, the agitated petroleum coke proppant particulates may be introduced in a pre-pad fracturing fluid comprising a slickwater carrier fluid designed to fill the well and initiate one or more fractures. As such, the agitated petroleum may be introduced into the fractures at an early stage and thereafter continuously pushed toward far-field areas of the fractures as they continue to grow in later pumping phases. In such instances, it is desirable that all of the proppant particulates in the pre-pad are lightweight proppant particulates, such as agitated petroleum coke proppant particulates.

In additional aspects, the agitated petroleum coke proppant particulates may be introduced after about ⅛ to about ¾ of the total volume of fracturing fluid has been injected within a formation. Because of the low density of the agitated petroleum coke proppant particulates, additional introduction of the agitated petroleum coke proppant particulates during later time periods up to and including completion of fracturing after which the fracture(s) have already grown substantially, such that the agitated petroleum coke proppant particulates can travel within the fracturing fluid to remote locations of the formed fracture(s) between interstitial areas that denser proppant particulates would not be able to reach due to settling effects, for example. In these later stages, the agitated petroleum coke proppant particulates may be mixed with other proppant particulates, such as traditional (e.g., sand) proppant particulates. It is expected that, when included, at least about 5 to about 10 vol% to about 90 vol% of any proppant particulates will be the agitated petroleum coke proppant particulates, encompassing any value and subset therebetween.

The hydraulic fracturing methods described herein may be performed in drilled horizontal, vertical, or tortuous wellbores, hydrocarbon-producing (e.g., oil and/or gas) wellbores and water-producing wellbores. These wellbores may be in various subterranean formation types including, but not limited to, shale formations, oil sands, gas sands, and the like.

The wellbores are typically completed using a metal (e.g., steel) tubular or casing that is cemented into the subterranean formation. To contact the formation, a plurality of perforations are created through the tubular and cement along a section to be treated, usually referred to as a plug and perforated (“plug and perf”) cased-hole completion. Alternative completion techniques may be used without departing from the scope of the present disclosure, but in each technique, a finite length of the wellbore is exposed for hydraulic fracturing and injection of fracturing fluid. This finite section is referred to herein as a “stage.” In plug and perf completions, the stage length may be based a distance over which the tubular and cement have been perforated, and may be in the range of about 10 feet (ft) to about 2000 ft, for example, and more generally in the range of about 100 ft to about 300 ft, encompassing any value and subset therebetween. The stage is isolated (e.g., sliding sleeve, ball) such that pressurized fracturing fluid from the surface can flow through the perforations and into the formation to generate one or more fractures in only the stage area. Clusters of perforations may be used to facilitate initiation of multiple fractures. For example, clusters of perforations may be made in sections of the stage that are about 1 ft to about 3 ft in length, and spaced apart by about 2 ft to about 100 ft, encompassing any value and subset therebetween.

For each linear foot of the stage, at least about 6 barrels (about 24 cubic feet (ft³)), or at least about 24 barrels (about 135 ft³), or at least 60 barrels (about 335 ft³) and less than 6000 barrels (about 33,500 ft³) of fracturing fluid may be injected to grow the one or more fractures, encompassing any value and subset therebetween. In certain aspects, for each linear foot of the stage, at least about 1.6 ft³, preferably about 6.4 ft³, and more preferably at least 16 ft³ and less than 1600 ft³ of proppant particulates may be injected to prop the fractures. In some aspects, to prevent bridging of the proppant particulates during injection into the fractures, the ratio of the volume of the proppant particulates to the liquid portion of the fracturing fluid, primarily the carrier fluid, is greater than 0 and less than about 0.25 and preferably less than about 0.15. If the volume ratio becomes too large, a phenomena known as “sanding out” will occur.

Certain commercial operations, such as commercial shale fracturing operations, may be particularly suitable for hydraulic fracturing using the agitated petroleum coke proppant particulates and methods described herein, as the mass of proppant particulates required per stage in such operations can be quite large and substantial economic benefit may be derived using the agitated petroleum coke proppant particulates. Indeed, in some instances, a stage in a shale formation may be designed to require at least about 30,000, at least about 100,000, or at least about 250,000 pounds (mass) of proppant particulates, encompassing any value and subset therebetween. In such cases, economic and performance benefit may be optimized when at least about 5%, or at least about 25%, and up to 100% of the proppant particulate mass comprises agitated petroleum coke proppant particulates.

Multiple stages of the wellbore are isolated and hydraulic fracturing performed at each stage. The agitated petroleum coke proppant particulates of the present disclosure may be used in any one, more, or all stages, including at least 2 stages, at least 10 stages, or at least 20 stages.

### Example Embodiments

Nonlimiting example embodiments of the present disclosure include:

Embodiment A: A proppant particulate comprising: a petroleum coke particle composed of at least one of fluid coke or flexicoke, wherein the petroleum coke particle has undergone agitation processing.

Embodiment B: A fracturing fluid comprising: a carrier fluid; and proppant particulates comprising a petroleum coke particle composed of fluid coke or flexicoke, wherein the petroleum coke particle has undergone agitation processing.

Embodiment C: A method comprising: providing petroleum coke particles composed of fluid coke or flexicoke; and agitation processing the petroleum coke particles, thereby producing agitation processed petroleum coke proppant particulates.

Nonlimiting example embodiments A, B, or C may include one or more of the following elements.

Element 1: Wherein the agitation processing comprises transloading agitation.

Element 2: Wherein the agitation processing comprises drying agitation.

Element 3: Wherein the agitation processing comprises sieving agitation.

Element 4: Wherein the petroleum coke is fluid coke.

Element 5: Wherein the petroleum coke is flexicoke.

Element 6: Wherein the proppant particulate has a particle density of equal to or less than about 1.7 grams per centimeter.

Element 7: Wherein the proppant particulate has an average diameter in the range of about 60 micrometers to about 600 micrometers.

Element 8: Wherein the proppant particulate has a Krumbein sphericity value of ≥ 0.6.

Element 9: Wherein the proppant particulate has a Krumbein roundness value of ≥ 0.6.

Element 10: Wherein the proppant particulate has a particle density in the range of about 1.4 grams per cubic centimeter to about 1.6 grams per cubic centimeter.

Element 11: Wherein the proppant particulates have a crush strength of about 2,000 psi to about 12,000 psi.

Element 12: Further comprising introducing the agitation processed petroleum coke proppant particulates into a subterranean formation in a fracturing fluid comprising a carrier fluid.

Embodiments A, B, and C may be in any combination with one, more or all of Elements 1 and 2, 1 and 3, 1 and 4, 1 and 5, 1 and 6, 1 and 7, 1 and 8, 1 and 9, 1 and 10, 1 and 11, 2 and 3, 2 and 4, 2 and 5, 2 and 6, 2 and 7, 2 and 8, 2 and 9, 2 and 10, 2 and 11, 3 and 4, 3 and 5, 3 and 6, 3 and 7, 3 and 8, 3 and 9, 3 and 10, 3 and 11, 4 and 5, 4 and 6, 4 and 7, 4 and 8, 4 and 9, 4 and 10, 4 and 11, 5 and 6, 5 and 7, 5 and 8, 5 and 9, 5 and 10, 5 and 11, 6 and 7, 6 and 8, 6 and 9, 6 and 10, 6 and 11, 7 and 8, 7 and 9, 7 and 10, 7 and 11, 8 and 9, 8 and 10, 8 and 11, 9 and 10, 9 and 11, and any other nonlimiting combinations of 1 through 11.

Embodiments B and C may be in any combination in addition to the above combinations with Element 12.

Unless otherwise indicated, all numbers expressing quantities of ingredients, properties such as molecular weight, reaction conditions, and so forth used in the present specification and associated claims are to be understood as being modified in all instances by the term “about,” and take into account experimental error and variations that would be expected by a person having ordinary skill in the art. Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer’s goals, such as compliance with system-related, business-related, government-related and other constraints, which vary by implementation and from time to time. While a developer’s efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Accordingly, the agitated petroleum coke proppant particulates of the present disclosure are suitable for use in fracturing operations, including in unconventional formation types.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

Therefore, the present disclosure is well adapted to attain the ends and advantages mentioned as well as those that are inherent therein. The particular examples and configurations disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A proppant particulate comprising:
a petroleum coke particle composed of at least one of fluid coke or flexicoke, wherein the petroleum coke particle has undergone agitation processing.

2. The proppant particulate of claim 1, wherein the agitation processing comprises transloading agitation.

3. The proppant particulate of claim 1, wherein the agitation processing comprises drying agitation.

4. The proppant particulate of claim 1, wherein the agitation processing comprises sieving agitation.

5. The proppant particulate of claim 1, wherein the petroleum coke is fluid coke.

6. The proppant particulate of claim 1, wherein the petroleum coke is flexicoke.

7. The proppant particulate of claim 1, wherein the proppant particulate has a particle density of equal to or less than about 1.6 grams per centimeter.

8. A fracturing fluid comprising:
a carrier fluid; and
proppant particulates comprising a petroleum coke particle composed of fluid coke or flexicoke, wherein the petroleum coke particle has undergone agitation processing.

9. The fracturing fluid of claim 8, wherein the agitation processing comprises transloading agitation.

10. The fracturing fluid of claim 8, wherein the agitation processing comprises drying agitation.

11. The fracturing fluid of claim 8, wherein the agitation processing comprises sieving agitation.

12. The fracturing fluid of claim 8, wherein the petroleum coke is fluid coke.

13. The fracturing fluid of claim 8, wherein the petroleum coke is flexicoke.

14. The fracturing fluid of claim 8, wherein the proppant particulate has a particle density of equal to or less than about 1.6 grams per centimeter.

15. A method comprising:
providing petroleum coke particles composed of fluid coke or flexicoke; and
agitation processing the petroleum coke particles, thereby producing agitation processed petroleum coke proppant particulates.

16. The method of claim 15, wherein the agitation processing comprises transloading agitation.

17. The method of claim 15, wherein the agitation processing comprises drying agitation.

18. The method of claim 15, wherein the agitation processing comprises sieving agitation.

19. The method of claim 15, wherein the petroleum coke is fluid coke.

20. The method of claim 15, wherein the petroleum coke is flexicoke.

21. The method of claim 15, wherein the proppant particulate has a particle density of equal to or less than about 1.6 grams per centimeter.

22. The method of claim 15, further comprising introducing the agitation processed petroleum coke proppant particulates into a subterranean formation in a fracturing fluid comprising a carrier fluid.
